(19) United States
(12) Patent Application Publication
(10) Pub. No.: US 2022/0081157 A1
(43) Pub. Date: Mar. 17, 2022

(54) FLOOR DECKER

(71) Applicants: Haiwei LI, Guangdong (CN); Yipeng ZHANG, Guangdong (CN)

(72) Inventors: Haiwei LI, Guangdong (CN); Yipeng ZHANG, Guangdong (CN)

(21) Appl. No.: 17/259,440

(22) PCT Filed: Oct. 29, 2020
(86) PCT No.: PCT/CN2020/124959

§ 371 Date: Jan. 11, 2021

(30) Foreign Application Priority Data
Dec. 30, 2019 (CN) 201911396318.5

(51) Int. Cl. B65D 19/00; B65D 19/40

(52) U.S. Cl. CPC B65D 19/0097; B65D 19/40; B65D 2519/00308; B65D 2519/00562; B65D 2519/00059; B65D 2519/00323; B65D 2519/00338; B65D 2519/00024; B65D 2519/00572; B65D 2519/00273; B65D 2519/00293

(57) ABSTRACT

Disclosed is a floor decker, which includes: a first metal plate, a plurality of first protrusions are formed on the first metal plate by stamping; and a second metal plate disposed below the first metal plate, a lower end surface of each of the plurality of first protrusions is attached to an upper end surface of the second metal plate, and the first metal plate is fixedly connected to an edge of the second metal plate, and a plurality of supporting legs are provided at a lower end of the second metal plate.

### TECHNICAL FIELD

The present invention relates to a floor decker.

### BACKGROUND

Floor deckers are supporting structures for bearing materials or products, which are widely used in machinery, electronics, food, medicine, clothing and other industries. Currently, common floor deckers are wooden boards and plastic boards. The wooden boards may easily absorb moisture and get moldy on rainy days, and need to be fumigated before being used again; the wooden boards are susceptible to pests, and need to be disinfected before the final products can be obtained, so the production process is complicated, the production costs are high, and the market competitiveness is weak; and the wooden boards may be easily damaged, and raised burrs may easily penetrate into a packing bag and be mixed into the products, which affects the product quality. The plastic boards can bear only light weight and may be easily crushed. In addition, the floor deckers made of wooden or plastic materials have insufficient strength and may be easily damaged.

### SUMMARY

The present invention aims to address one of the above technical problems in related technologies to at least a certain extent. In view of this, the present invention provides a floor decker, which is made of a first metal plate and a second metal plate that are thin. An upper end of the first metal plate is punched downward to form a plurality of first protrusions, and the plurality of first protrusions fill gaps between the first metal plate and the second metal plate to form a honeycomb-like structure, thereby improving the strength of the floor decker, increasing the bearing capacity, and reducing the overall weight.

The floor decker according to an embodiment of the present invention includes a first metal plate, a plurality of first protrusions are formed on the first metal plate by stamping; and a second metal plate disposed below the first metal plate, wherein a lower end surface of each of the plurality of first protrusions is attached to an upper end surface of the second metal plate, and the first metal plate is fixedly connected to an edge of the second metal plate, and a plurality of supporting legs are provided at a lower end of the second metal plate.

The floor decker according to the embodiment of the present invention has at least the following technical effects: An upper end of the first metal plate is punched downward to form the plurality of first protrusions, the lower end surface of each of the plurality of first protrusion is attached to the upper end surface of the second metal plate, the plurality of first protrusions function as a supporting column and can fill gaps between the first metal plate and the second metal plate to form a honeycomb-like structure, thereby improving the connection strength between the first metal plate and the second metal plate, and increasing the bearing capacity of the floor decker; no supporting column needs to be arranged between the first metal plate and the second metal plate, thereby can not only simplify machining procedures and improve production efficiency, but also reduce the overall weight of the floor decker to facilitate carrying and use by operators; in addition, the floor decker can be assembled only with two thin metal plates and supporting legs, thereby being simple in structure and low in production cost; and the metal material is convenient to recycle, and thereby the floor decker being environment-friendly and saving resources.

According to some embodiments of the present invention, a plurality of second protrusions are formed on the second metal plate by stamping, and the lower end surface of each of the plurality of first protrusions is attached to a upper end surface of each of the plurality of second protrusions.

According to some embodiments of the present invention, a first through-hole for draining water is configured to penetrate between the first protrusions and the second protrusions in a vertical direction.

According to some embodiments of the present invention, a circular groove is formed in the first metal plate at a position corresponding to each of the plurality of first protrusions and in the second metal plate at a position corresponding to each of the plurality of second protrusions.

According to some embodiments of the present invention, each of the plurality of supporting legs is a hollow conical supporting leg, one end of the conical supporting leg connected to the second metal plate is a large-diameter end, and the first metal plate and the second metal plate are both provided with a plurality of third through-holes communicated with an inner cavity of the supporting leg.

According to some embodiments of the present invention, a plurality of second protrusions are formed on the second metal plate by stamping, the first plurality of protrusions are a plurality of hollow first bosses, and a plurality of fifth through-holes for embedding the plurality of hollow first bosses are formed in the plurality of second protrusions.

According to some embodiments of the present invention, an edge of the second metal plate is folded upward to form a first vertical edge, the first vertical edge is folded outward to form a U-shaped groove, an edge of the first metal plate is folded downward to form a second vertical edge surrounding the U-shaped groove, the second vertical edge is folded inward to form an arc-shaped first hook edge, and a tail end of the first hook edge is configured to abut against a side wall of the U-shaped groove.

According to some embodiments of the present invention, the edge of the second metal plate is folded upward to form a third vertical edge, the edge of the first metal plate is folded downward to form a fourth vertical edge surrounding the third vertical edge, and a lower end of the fourth vertical edge is fixed to a side wall of the third vertical edge through welding.

According to some embodiments of the present invention, the edge of the second metal plate is folded upward to form a fifth vertical edge, the edge of the first metal plate is folded downward to form a sixth vertical edge surrounding the fifth vertical edge, and the sixth vertical edge has a length greater than that of the fifth vertical edge; and a lower end of the sixth vertical edge is folded inward by 90° to form a horizontal hook edge, and an upper end surface of the horizontal hook edge is attached to a lower end surface of the second metal plate.

According to some embodiments of the present invention, the edge of the second metal plate is folded upward to form a seventh vertical edge, an upper end of the seventh vertical edge is folded inward to form a second arc edge, a tail end of the second arc edge is configured to abut against the upper end surface of the second metal plate, the edge of the first metal plate is folded downward to form an eighth vertical edge surrounding the seventh vertical edge, a lower end of the eighth vertical edge is folded inward to form a third arc edge, a tail end of the third arc edge abuts against the lower end surface of the first metal plate, and a middle portion of the third arc edge is attached to an outer side wall of the seventh vertical edge and fixed through welding.

The additional aspects and advantages of the present invention will be partly presented in the following description, partly become apparent in the following description or be appreciated through practice of the present invention.

### BRIEF DESCRIPTION OF THE DRAWINGS

The above and/or additional aspects and advantages of the present invention will become apparent and readily understood with reference to the description of embodiments taken with reference to the following accompanying drawings, in which:

FIG. 1 is a schematic top view of a structure according to an embodiment of the present invention;

FIG. 2 is an enlarged schematic diagram of a position B in FIG. 1;

FIG. 3 is a schematic sectional view of a structure at a position A-A in FIG. 1;

FIG. 4 is an enlarged schematic diagram of a position C in FIG. 3;

FIG. 5 is an enlarged schematic diagram of a position D in FIG. 3;

FIG. 6 is a perspective schematic view of a structure according to an embodiment of the present invention;

FIG. 7 is an enlarged schematic diagram of a position E in FIG. 6;

FIG. 8 is a schematic view of an assembly structure of a second metal plate and supporting legs according to an embodiment of the present invention;

FIG. 9 is an enlarged schematic diagram of a position F in FIG. 8;

FIG. 10 is a schematic structural diagram of a first metal plate according to an embodiment of the present invention;

FIG. 11 is an enlarged schematic diagram of a position G in FIG. 10;

FIG. 12 is a schematic sectional front view of a structure according to a second embodiment of the present invention;

FIG. 13 is an enlarged schematic diagram of a position H in FIG. 12;

FIG. 14 is a schematic sectional front view of a structure according to a third embodiment of the present invention;

FIG. 15 is an enlarged schematic diagram of a position I in FIG. 14;

FIG. 16 is a schematic sectional front view of a structure according to a fourth embodiment of the present invention;

FIG. 17 is an enlarged schematic diagram of a position J in FIG. 16;

FIG. 18 is a schematic sectional front view of a structure according to a fifth embodiment of the present invention; and

FIG. 19 is an enlarged schematic diagram of a position K in FIG. 18.

### REFERENCE SIGNS

100. First metal plate, 110. First protrusion, 120. First vertical edge, 130. First hook edge, 140. Fourth vertical edge, 150. Sixth vertical edge, 160. Horizontal hook edge, 170. First L-shaped folded edge, 180. Second boss, 190. Eighth vertical edge, 191. Third arc edge, 200. Second metal plate, 210. Second protrusion, 220. Second vertical edge, 230. U-shaped groove, 240. Third vertical edge, 250. Fifth vertical edge, 260. Second L-shaped folded edge, 270. Seventh vertical edge, 271. Second arc edge;
300. Supporting leg, 310. Second through-hole;
410. First through-hole, 420. Third through-hole, 430. Circular groove.

### DETAILED DESCRIPTION

This section will describe some embodiments of the present invention in detail, and the preferred embodiments of the present invention are shown in the accompanying drawings. The function of the accompanying drawings is to supplement the description of the text part of the specification with graphics, so that people can visually and vividly understand each technical feature and the overall technical solution of the present invention, but the accompanying drawings cannot be understood as limiting the protection scope of the present invention.

In the description of the present invention, it should be understood that if orientation description is involved, the orientation or position relationship indicated by, for example, “up”, “down”, “front”, “rear”, “left”, and “right” is based on the orientation or position relationship shown in the drawings, and these terms are just used to facilitate description of the present invention and simplify the description, but not to indicate or imply that the mentioned device or elements must have a specific orientation and must be established and operated in a specific orientation, and thus, these terms cannot be understood as a limitation to the present invention.

In the description of the present invention, “first”, “second”, “third”, “fourth”, “fifth”, and “sixth” in description are only for the purpose of distinguishing technical features, and cannot be understood as indicating or implying relative importance or implicitly indicating the number of technical features indicated or implicitly indicating the sequence relationship of indicated technical features.

In the description of the present invention, unless otherwise explicitly defined, the words such as “setting”, “mounting”, and “connecting” should be understood in a broad sense, and those skilled in art can properly determine the specific meanings of the above words in the present invention with reference to the specific contents of the technical solution.

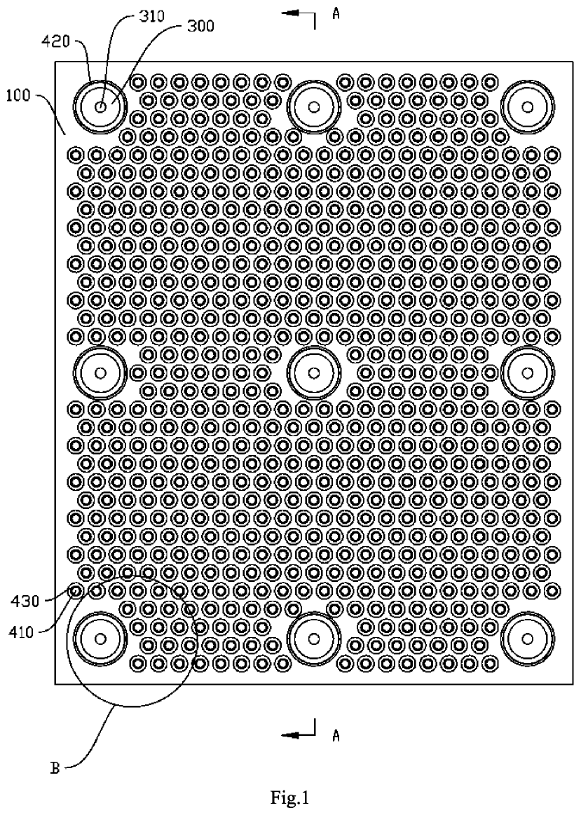

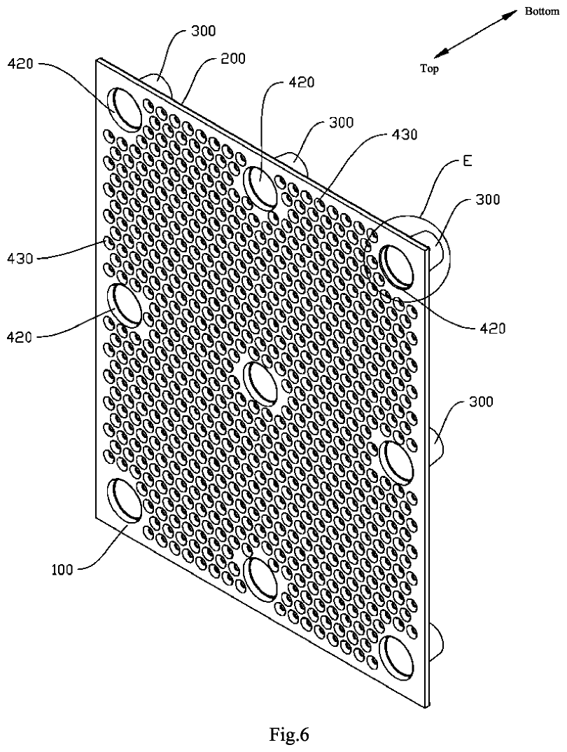

Referring to FIG. 1 to FIG. 7, a floor decker according to an embodiment of the present invention includes a first metal plate 100 and a second metal plate 200, and an upper end of the first metal plate 100 is punched downward to form a plurality of first protrusions 110; the second metal plate 200 is disposed below the first metal plate 100, a lower end surface of the first protrusion 110 is attached to an upper end surface of the second metal plate 200, and the first metal plate 100 is fixedly connected to an edge of the second metal plate 200; and a lower end of the second metal plate 200 is provided with a plurality of supporting legs 300. Compared with the prior art, in the embodiment of the present invention, the upper end of the first metal plate 100 is punched downward to form the plurality of first protrusions 110, the lower end surface of each first protrusion 110 is attached to the upper end surface of the second metal plate 200, the first protrusion 110 functions as a supporting column and can fill gaps between the first metal plate 100 and the second metal plate 200 to form a honeycomb-like structure, which improves the connection strength between the first metal plate 100 and the second metal plate 200, thereby increasing the bearing capacity of the floor decker; no supporting column needs to be arranged between the first metal plate 100 and the second metal plate 200, which can not only simplify machining procedures and improve production efficiency, but also reduce the overall weight of the floor decker to facilitate carrying and use by operators; the upper end surface of the first metal plate 100 is punched downward to form the plurality of first protrusions 110, so that the upper end surface of the first metal plate 100 is a non-smooth plane, which increases a friction force between the first metal plate 100 and goods, prevents the goods from slipping under the action of an external force, and is safe to use; in addition, the floor decker can be assembled only with two thin metal plates and supporting legs 300, which is simple in structure and low in production cost; and the metal material is convenient to recycle, and thus the floor decker is environment-friendly and saves resources. Specifically, the first metal plate 100 and the second metal plate 200 are made of galvanized sheets or electrolytic sheets. The galvanized sheets and the electrolytic sheets have high strength, high ductility, corrosion resistance and nuclear radiation resistance, efficiently reflect ultraviolet rays and are easy to machine, light, recyclable, free of insects and low-carbon and environment-friendly, so using the galvanized sheets or the electrolytic sheets to make the floor decker fully meet the use requirements for the floor decker. The floor decker made of the galvanized sheets or the electrolytic sheets generates little waste after being dismantled, and the recovery rate of the floor decker made of the removed galvanized sheets or electrolytic sheets is over 80%, which meets the requirements of environmental protection efficiency. It can be understood that the same technical effect can be achieved by stamping the second metal plate 200 to form the first protrusion 110, and attaching the upper end surface of the first protrusion 110 to the lower end surface of the first metal plate 100.

Further, there are nine supporting legs 300, and the nine supporting legs 300 are uniformly arranged at the lower end of the second metal plate 200 in three rows and three columns. As such, the floor decker can be better fixed, thereby preventing the floor decker from moving or deforming during working. Certainly, four, six, twelve or another number of supporting legs 300 may be arranged based on the actual size of the floor decker. The specific number of the supporting legs 300 is not limited herein.

As shown in FIG. 1 to FIG. 7, in some embodiments of the present invention, a plurality of second protrusions 210 are formed on the second metal plate 200 by stamping, and the lower end surfaces of the first protrusions 110 are attached to the upper end surfaces of the second protrusions 210. The second metal plate 200 is punched to form the plurality of second protrusions 210, and the second protrusions 210 are aligned with and attached to the first protrusions 110 to form columns, which further improves the connection strength between the first metal plate 100 and the second metal plate 200. In addition, the first protrusions 110 and the second protrusions 210 are aligned and connected with each other, which can further a gap between the first metal plate 100 and the second metal plate 200, so that the thicknesses of the first metal plate 100 and the second metal plate 200 can be further reduced while the strength requirements are met, thereby reducing production costs and the overall weight of the floor decker according to the embodiment of the present invention. It can be understood that the number of the first protrusions 110 is equal to the number of the second protrusions 210.

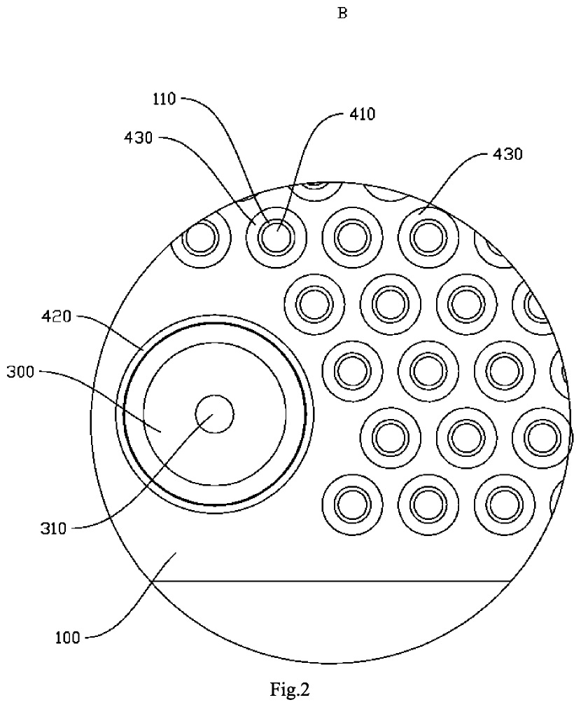

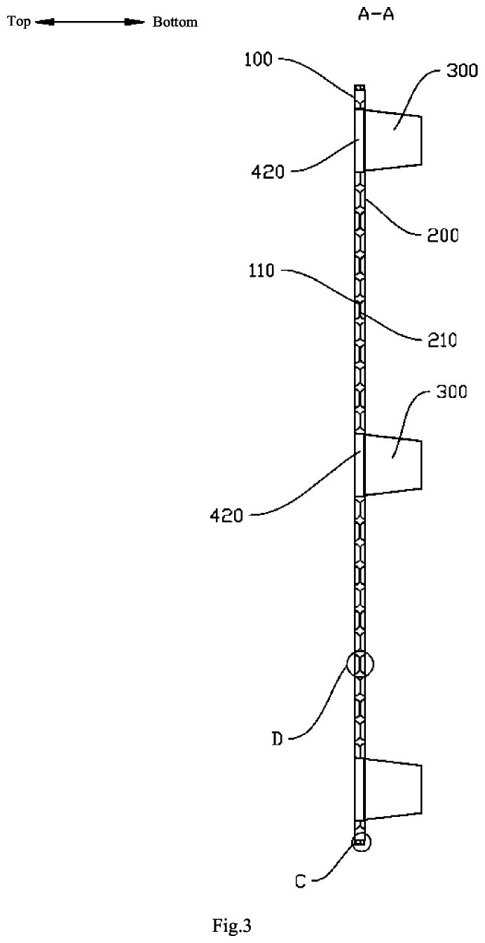

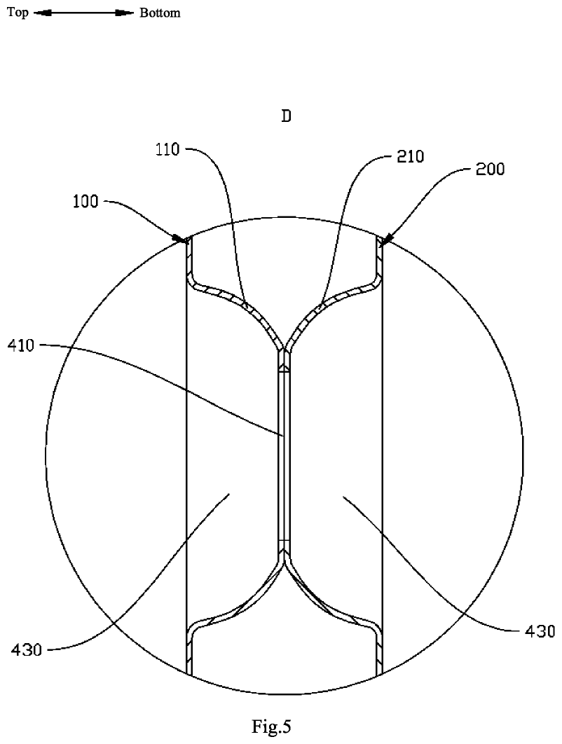

As shown in FIG. 1, FIG. 2, FIG. 3 and FIG. 5, further, to prevent water from accumulating in a groove of the first metal plate 100 at the position corresponding to the first protrusion 110 when wet goods are transferred and affecting use, a first through-hole 410 for draining water penetrates between the first protrusions 110 and the second protrusions 210 in a vertical direction. By providing the first through-hole 410, the water can be quickly discharged after the floor decker is cleaned. Specifically, attaching positions between the first protrusions 110 and the second protrusions 210 are fixed through spot welding to further improve the fastening performance of connection between the first protrusions 110 and the second protrusions 210.

As shown in FIG. 5, in some embodiments of the present invention, circular grooves 430 are formed in the first metal plate 100 at positions corresponding to the first protrusions 110 and in the second metal plate 200 at positions corresponding to the second protrusions 210. As such, the first protrusions 110 and the second protrusions 210 are formed on first metal plate 100 and the second metal plate 200 by stamping, thereby facilitating production. The first protrusions 110 and the second protrusions 210 are set into a circular shape, so that the contact area between the lower end surfaces of the first protrusions 110 and the upper end surfaces of the second protrusions 210 can be increased, and the supporting effect is more ideal. Certainly, according to the actual needs, the positions of the first metal plate 100 corresponding to the first protrusions 110 and the positions of the second metal plate 200 corresponding to the second protrusions 210 are set into grooves that are square or in other shapes, so that the first protrusions 110 and the second protrusions 210 can also be formed by stamping, to achieve the same technical effect.

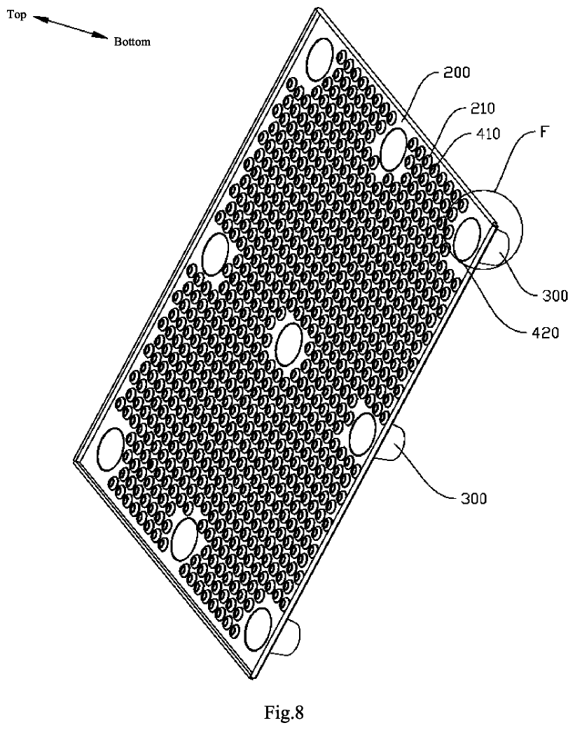

As shown in FIG. 1 to FIG. 3 and FIG. 6 to FIG. 9, in some embodiments of the present invention, the supporting leg 300 is a hollow conical supporting leg, and one end of the conical supporting leg connected to the second metal plate 200 is a large-diameter end. The first metal plate 100 and the second metal plate 200 are both provided with third through-holes 420 communicated with an inner cavity of the supporting leg 300. As such, during transportation, the supporting leg 300 of one floor decker can pass through the third through-hole 420 and is placed in the inner cavity of the supporting leg 300 of another floor decker, so that a plurality of floor deckers are stacked together, which reduces the occupied area of the plurality of floor deckers according to the embodiment of the present invention during packing and transportation and reduces transportation costs. In addition, when the floor deckers are idle, they can be stacked together, which reduces the occupied area and saves storage space. Specifically, to prevent water from accumulating in the hollow supporting leg 300, the second through-hole 310 passes through the lower end surface of the supporting leg 300.

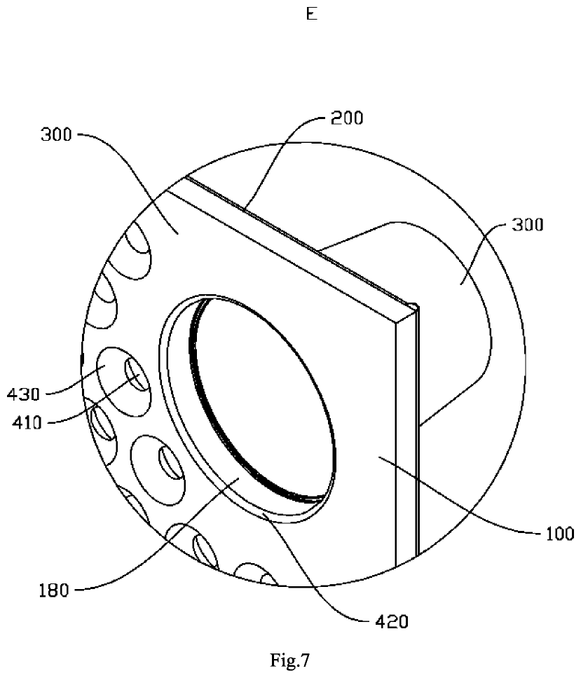

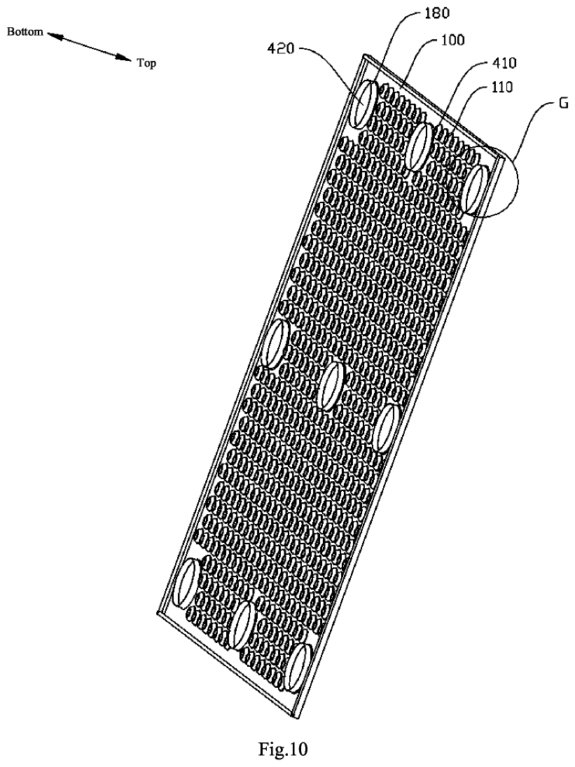

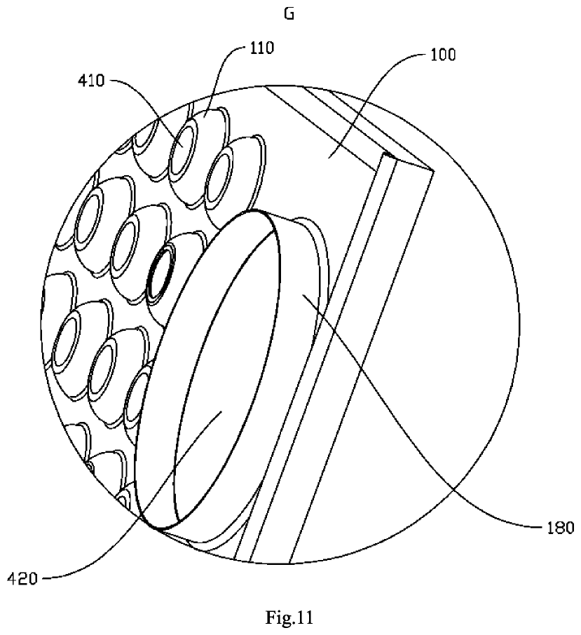

As shown in FIG. 7, FIG. 10 and FIG. 11, further, a second boss 180 is disposed at the lower end of the first metal plate 100 at the position corresponding to the supporting leg 300, a lower end surface of the second boss 180 is attached to the upper end surface of the second metal plate 200, and the third through-hole 420 passes through the second boss 180. As such, the hollow second boss 180 has the same function as the first protrusions 110 and the second protrusions 210, and functions to fill the gap between the first metal plate 100 and the second metal plate 200, thereby enhancing the strength of the positions of the floor decker where the supporting legs 300 are arranged.

In another embodiment of the present invention, the second metal plate 200 is punched to form a plurality of second protrusions 210, the first protrusions 110 are hollow first bosses, and fifth through-holes for embedding the first bosses are formed in the second protrusions 210. As such, when the first metal plate 100 and the second metal plate 200 are assembled, the first protrusions 110 are embedded in the fifth through-holes correspondingly embedded in the corresponding second protrusions 210, the upper end surfaces of the second protrusions 210 are attached to the lower end surface of the first metal plate 100. This can prevent the first metal plate 100 from moving relative to the second metal plate 200 in the process of fixedly connecting the first metal plate 100 to the edge of the second metal plate 200, to assemble the first metal plate 100 and the second metal plate 200 into a whole.

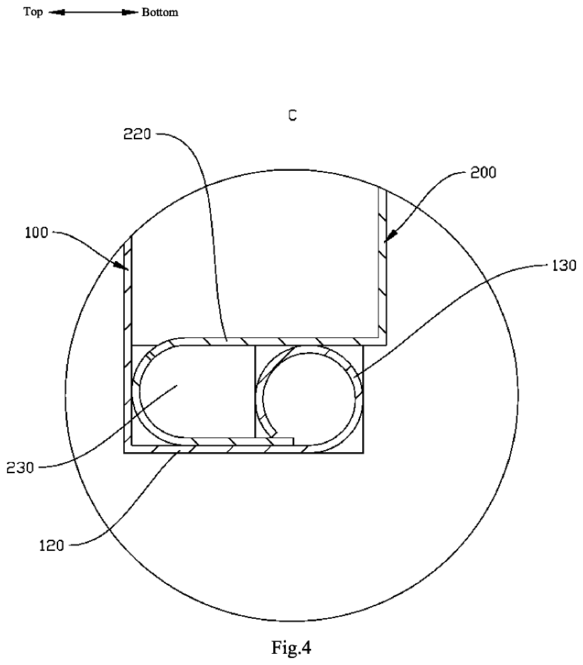

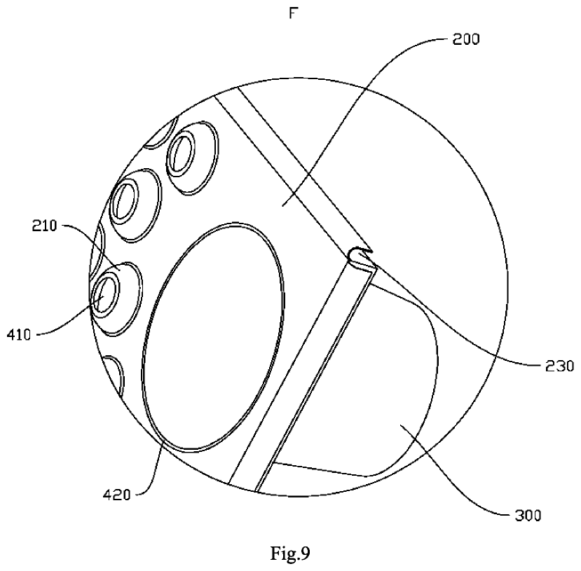

As shown in FIG. 3, FIG. 4 and FIG. 9, in some embodiments of the present invention, an edge of the second metal plate 200 is folded upward to form a first vertical edge 220, the first vertical edge 220 is folded outward to form a U-shaped groove 230, an edge of the first metal plate 100 is folded downward to form a second vertical edge 120 surrounding the U-shaped groove 230, the second vertical edge 120 is folded inward to form an arc-shaped first hook edge 130, and a tail end of the first hook edge 130 abuts against a side wall of the U-shaped groove 230. As such, the tail end of the first hook edge 130 always abuts against a side wall of the U-shaped groove 230, so that the first metal plate 100 is fixedly connected to the edge of the second metal plate 200. This prevents the situation that during use of the floor decker, the first metal plate 100 is shifted relative to the second metal plate 200, resulting in misalignment contact between the first protrusion 110 and the second protrusion 210. Therefore, the strength of the floor decker according to the embodiment of the present invention meets the use requirements.

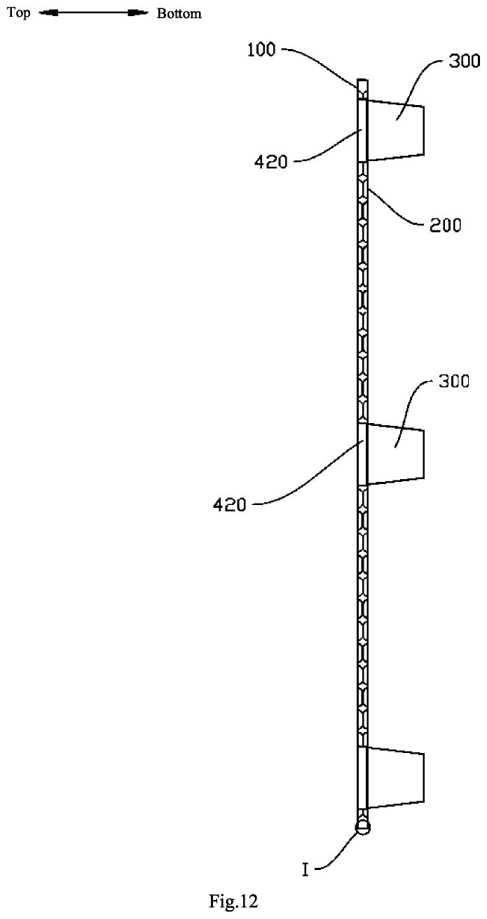

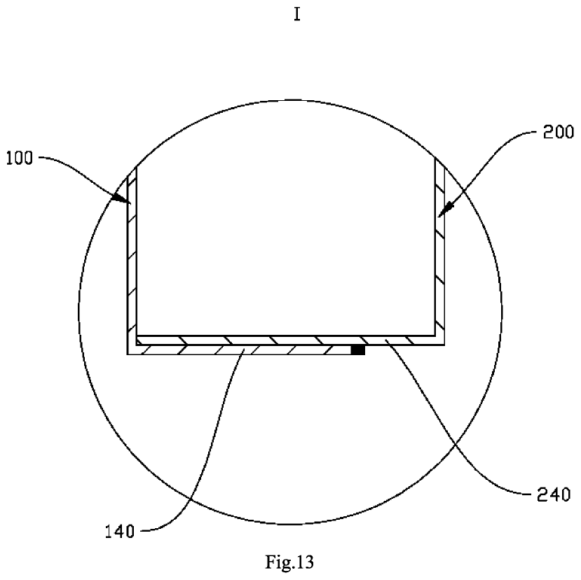

As shown in FIG. 12 and FIG. 13, in a second embodiment of the present invention, the edge of the second metal plate 200 is folded upward to form a third vertical edge 240, and the edge of the first metal plate 100 is folded downward to form a fourth vertical edge 140 surrounding the third vertical edge 240. A lower end of the fourth vertical edge 140 is fixed to a side wall of the third vertical edge 240 through welding. The lower end of the fourth vertical edge 140 is fixed to the side wall of the third vertical edge 240 through spot welding, so that the edge of the first metal plate 100 wraps the edge of the second metal plate 200, and thus the second metal plate 200 is fixedly connected in a cavity defined by the edge of the first metal plate 100; and no displacement occurs between the first metal plate 100 and the second metal plate 200, thereby ensuring that the first protrusion 110 and the second protrusion 210 are always in alignment contact, and ensuring that the strength of the floor decker according to the embodiment of the present invention meets the use requirements.

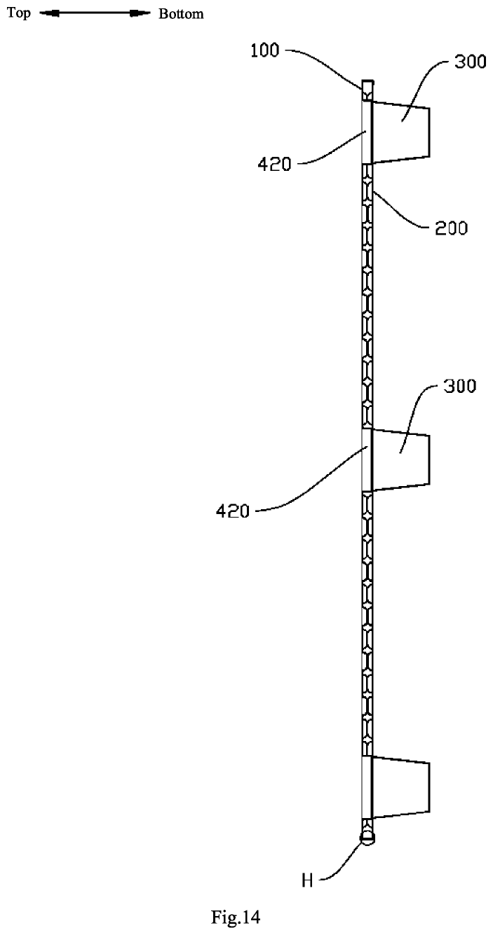

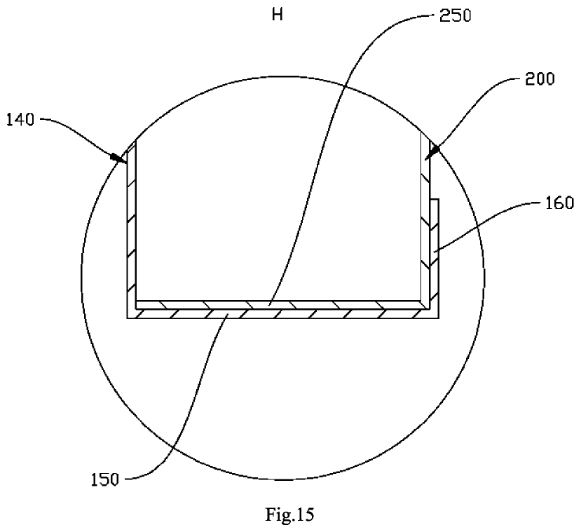

As shown in FIG. 14 and FIG. 15, in a third embodiment of the present invention, the edge of the second metal plate 200 is folded upward to form a fifth vertical edge 250, the edge of the first metal plate 100 is folded downward to form a sixth vertical edge 150 surrounding the fifth vertical edge 250, and the length of the sixth vertical edge 150 is greater than that of the fifth vertical edge 250. A lower end of the sixth vertical edge 150 is folded inward by 90° to form a horizontal hook edge 160, and an upper end surface of the horizontal hook edge 160 is attached to the lower end surface of the second metal plate 200. As such, the first vertical edge 220 on the first metal plate 100 and the horizontal hook edge 160 wrap the edge of the first metal plate 100, so that the first metal plate 100 and the second metal plate 200 are connected to be a whole, thereby preventing the first metal plate 100 from moving relative to the second metal plate 200.

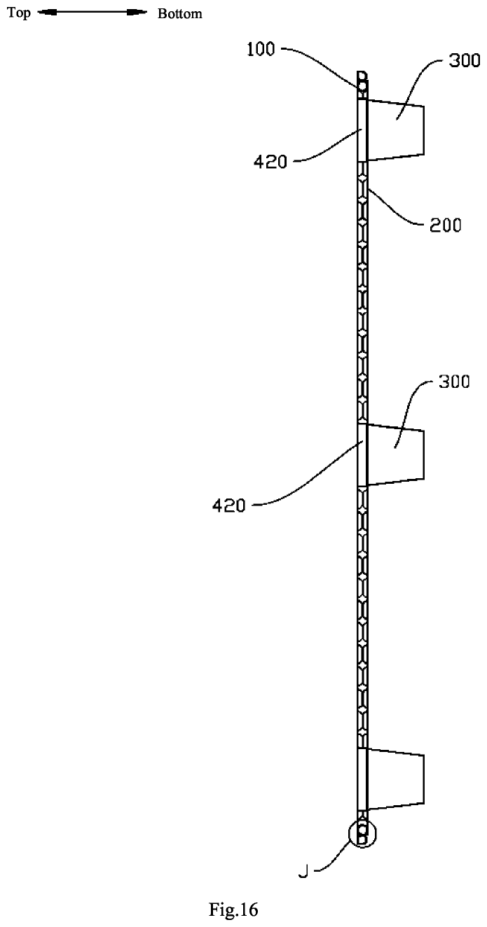

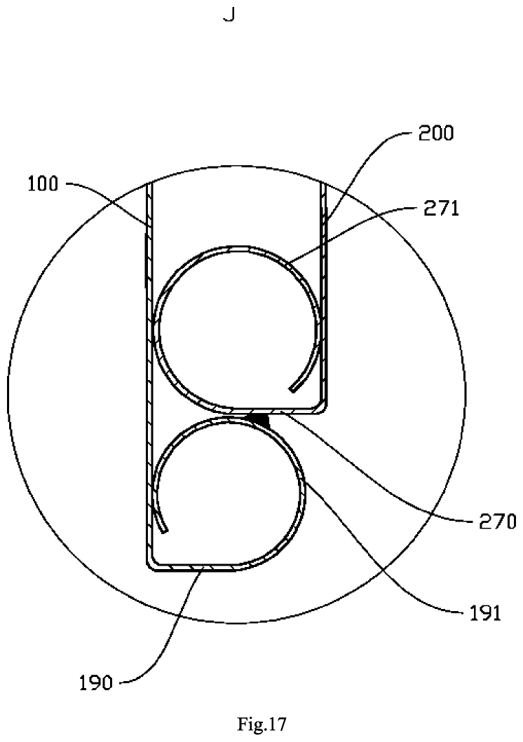

As shown in FIG. 16 and FIG. 17, in a fourth embodiment of the present invention, the edge of the second metal plate 200 is folded upward to form a seventh vertical edge 270, an upper end of the seventh vertical edge 270 is folded inward to form a second arc edge 271, a tail end of the second arc edge 271 abuts against the upper end surface of the second metal plate 200, the edge of the first metal plate 100 is folded downward to form an eighth vertical edge 190 surrounding the seventh vertical edge 270, a lower end of the eighth vertical edge 190 is folded inward to form a third arc edge 191, a tail end of the third arc edge 191 abuts against the lower end surface of the first metal plate 100, and a middle portion of the third arc edge 191 is attached to an outer side wall of the seventh vertical edge 270 and fixed through welding. The third arc edge 191 and the second arc edge 271 are folded on the first metal plate 100 and the edge of the second metal plate 200, respectively, the tail end of the third arc edge 191 abuts against the lower end surface of the first metal plate 100, and the tail end of the second arc edge 271 abuts against the upper end surface of the second metal plate 200, so that the strength of the floor decker according to the embodiment of the present invention can be further improved. The middle portion of the third arc edge 191 is attached and fixed to the outer side wall of the seventh vertical edge 270 through spot welding, so that the first metal plate 100 and the second metal plate 200 are connected to be a whole, thereby preventing the first metal plate 100 from moving relative to the second metal plate 200.

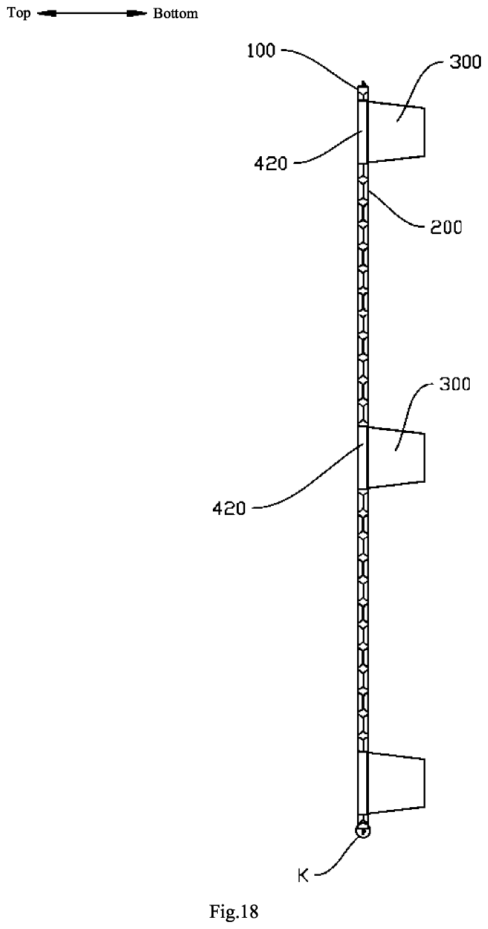

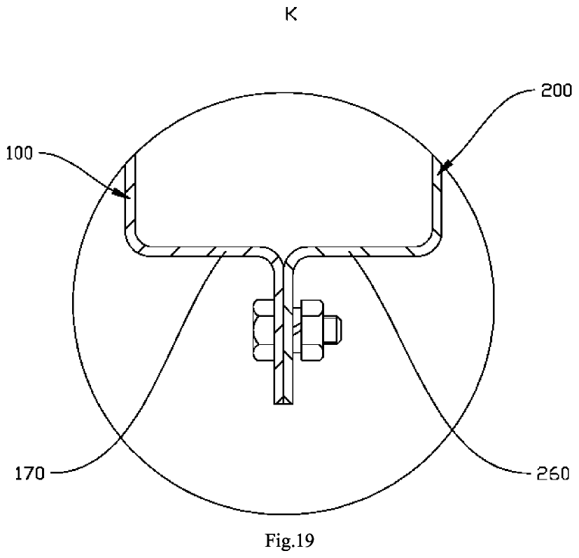

As shown in FIG. 18 and FIG. 19, in a fifth embodiment of the present invention, the edge of the first metal plate 100 is folded downward to form a first L-shaped folded edge 170, the edge of the second metal plate 200 is folded upward to form a second L-shaped folded edge 260, a lower end surface of the first L-shaped folded edge 170 is attached to an upper end surface of the second L-shaped folded edge 260, fourth through-holes pass through the first L-shaped folded edge 170 and the second L-shaped folded edge 260, and the fourth through-holes are for bolts to pass through and be matched with nuts for fixing. The first metal plate 100 is attached and fixed to the second metal plate 200 through matching between the bolts and the nuts, so that the first metal plate 100 is prevented from moving relative to the second metal plate 200, and the first protrusions 110 and the second protrusions 210 are always in alignment contact. Through the matching and connection between the bolts and the nuts, when the first metal plate 100 or the second metal plate 200 is damaged and cannot meet use requirements after being used for a period of time, the bolts and the nuts can be removed, so that the damaged part can be removed and replaced without replacing the whole floor decker, thereby reducing costs.

The above describes only preferred embodiments of the present invention, and is not used to limit the present invention. For those skilled in the art, there may be various modifications and changes to the present invention. Any modifications, equivalent replacements and improvements and the like made within the spirit and principles of the present invention should fall within the protection scope of the present invention.

1. A floor decker, comprising:
a first metal plate, wherein a plurality of first protrusions are formed on the first metal plate by stamping; and
a second metal plate disposed below the first metal plate, wherein a lower end surface of each of the plurality of first protrusions is attached to an upper end surface of the second metal plate, and the first metal plate is fixedly connected to an edge of the second metal plate, and a plurality of supporting legs are provided at a lower end of the second metal plate.

2. The floor decker of claim 1, wherein a plurality of second protrusions are formed on the second metal plate by stamping, and the lower end surface of each of the plurality of first protrusions is attached to a upper end surface of each of the plurality of second protrusions.

3. The floor decker of claim 2, wherein a first through-hole for draining water is configured to penetrate between the first protrusions and the second protrusions in a vertical direction.

4. The floor decker of claim 2, wherein a circular groove is formed in the first metal plate at a position corresponding to each of the plurality of first protrusions and in the second metal plate at a position corresponding to each of the plurality of second protrusions.

5. The floor decker of claim 1, wherein each of the plurality of supporting legs is a hollow conical supporting leg, one end of the conical supporting leg connected to the second metal plate is a large-diameter end, and the first metal plate and the second metal plate are both provided with a plurality of third through-holes communicated with an inner cavity of the supporting leg.

6. The floor decker of claim 1, wherein a plurality of second protrusions are formed on the second metal plate by stamping, the first plurality of protrusions are a plurality of hollow first bosses, and a plurality of fifth through-holes for embedding the plurality of hollow first bosses are formed in the plurality of second protrusions.

7. The floor decker of claim 1, wherein an edge of the second metal plate is folded upward to form a second vertical edge, the second vertical edge is folded outward to form a U-shaped groove, an edge of the first metal plate is folded downward to form a first vertical edge surrounding the U-shaped groove, the first vertical edge is folded inward to form an arc-shaped first hook edge, and a tail end of the first hook edge is configured to abut against a side wall of the U-shaped groove.

8. The floor decker of claim 1, wherein the edge of the second metal plate is folded upward to form a third vertical edge, the edge of the first metal plate is folded downward to form a fourth vertical edge surrounding the third vertical edge, and a lower end of the fourth vertical edge is fixed to a side wall of the third vertical edge through welding.

9. The floor decker of claim 1, wherein the edge of the second metal plate is folded upward to form a fifth vertical edge, the edge of the first metal plate is folded downward to form a sixth vertical edge surrounding the fifth vertical edge, and the sixth vertical edge has a length greater than that of the fifth vertical edge; and a lower end of the sixth vertical edge is folded inward by 90° to form a horizontal hook edge, and an upper end surface of the horizontal hook edge is attached to a lower end surface of the second metal plate.

10. The floor decker of claim 1, wherein the edge of the second metal plate is folded upward to form a seventh vertical edge, an upper end of the seventh vertical edge is folded inward to form a second arc edge, a tail end of the second arc edge is configured to abut against the upper end surface of the second metal plate, the edge of the first metal plate is folded downward to form an eighth vertical edge surrounding the seventh vertical edge, a lower end of the eighth vertical edge is folded inward to form a third arc edge, a tail end of the third arc edge abuts against the lower end surface of the first metal plate, and a middle portion of the third arc edge is attached to an outer side wall of the seventh vertical edge and fixed through welding.

11. The floor decker of claim 2, wherein an edge of the second metal plate is folded upward to form a second vertical edge, the second vertical edge is folded outward to form a U-shaped groove, an edge of the first metal plate is folded downward to form a first vertical edge surrounding the U-shaped groove, the first vertical edge is folded inward to form an arc-shaped first hook edge, and a tail end of the first hook edge is configured to abut against a side wall of the U-shaped groove.

12. The floor decker of claim 3, wherein an edge of the second metal plate is folded upward to form a second vertical edge, the second vertical edge is folded outward to form a U-shaped groove, an edge of the first metal plate is folded downward to form a first vertical edge surrounding the U-shaped groove, the first vertical edge is folded inward to form an arc-shaped first hook edge, and a tail end of the first hook edge is configured to abut against a side wall of the U-shaped groove.

13. The floor decker of claim 4, wherein an edge of the second metal plate is folded upward to form a second vertical edge, the second vertical edge is folded outward to form a U-shaped groove, an edge of the first metal plate is folded downward to form a first vertical edge surrounding the U-shaped groove, the first vertical edge is folded inward to form an arc-shaped first hook edge, and a tail end of the first hook edge is configured to abut against a side wall of the U-shaped groove.

14. The floor decker of claim 5, wherein an edge of the second metal plate is folded upward to form a second vertical edge, the second vertical edge is folded outward to form a U-shaped groove, an edge of the first metal plate is folded downward to form a first vertical edge surrounding the U-shaped groove, the first vertical edge is folded inward to form an arc-shaped first hook edge, and a tail end of the first hook edge is configured to abut against a side wall of the U-shaped groove.

15. The floor decker of claim 6, wherein an edge of the second metal plate is folded upward to form a second vertical edge, the second vertical edge is folded outward to form a U-shaped groove, an edge of the first metal plate is folded downward to form a first vertical edge surrounding the U-shaped groove, the first vertical edge is folded inward to form an arc-shaped first hook edge, and a tail end of the first hook edge is configured to abut against a side wall of the U-shaped groove.

16. The floor decker of claim 2, wherein the edge of the second metal plate is folded upward to form a third vertical edge, the edge of the first metal plate is folded downward to form a fourth vertical edge surrounding the third vertical edge, and a lower end of the fourth vertical edge is fixed to a side wall of the third vertical edge through welding.

17. The floor decker of claim 3, wherein the edge of the second metal plate is folded upward to form a third vertical edge, the edge of the first metal plate is folded downward to form a fourth vertical edge surrounding the third vertical edge, and a lower end of the fourth vertical edge is fixed to a side wall of the third vertical edge through welding.

18. The floor decker of claim 2, wherein the edge of the second metal plate is folded upward to form a fifth vertical edge, the edge of the first metal plate is folded downward to form a sixth vertical edge surrounding the fifth vertical edge, and the sixth vertical edge has a length greater than that of the fifth vertical edge; and a lower end of the sixth vertical edge is folded inward by 90° to form a horizontal hook edge, and an upper end surface of the horizontal hook edge is attached to a lower end surface of the second metal plate.

19. The floor decker of claim 4, wherein the edge of the second metal plate is folded upward to form a fifth vertical edge, the edge of the first metal plate is folded downward to form a sixth vertical edge surrounding the fifth vertical edge, and the sixth vertical edge has a length greater than that of the fifth vertical edge; and a lower end of the sixth vertical edge is folded inward by 90° to form a horizontal hook edge, and an upper end surface of the horizontal hook edge is attached to a lower end surface of the second metal plate.

20. The floor decker of claim 6, wherein the edge of the second metal plate is folded upward to form a seventh vertical edge, an upper end of the seventh vertical edge is folded inward to form a second arc edge, a tail end of the second arc edge is configured to abut against the upper end surface of the second metal plate, the edge of the first metal plate is folded downward to form an eighth vertical edge surrounding the seventh vertical edge, a lower end of the eighth vertical edge is folded inward to form a third arc edge, a tail end of the third arc edge abuts against the lower end surface of the first metal plate, and a middle portion of the third arc edge is attached to an outer side wall of the seventh vertical edge and fixed through welding.
